(19) United States
(12) Patent Application Publication
(10) Pub. No.: US 2018/0258904 A1
(43) Pub. Date: Sep. 13, 2018

(54) FLOATING MOON POOL HYDRAULIC PUMP

(71) Applicant: Thomas Gregory Gorman, Edgewater, MD (US)

(72) Inventor: Thomas Gregory Gorman, Edgewater, MD (US)

(21) Appl. No.: 15/554,639

(22) PCT Filed: Mar. 9, 2015
(86) PCT No.: PCT/US2015/019374

§ 371 Date: Aug. 30, 2017

(51) Int. Cl. F03B 13/20; F04B 53/10; F03B 15/08; F01D 15/10; B63B 35/44; B63B 3/14; B63B 21/50

(52) U.S. Cl. CPC F03B 13/20; F04B 53/10; F03B 15/08; F01D 15/10; B63B 2003/147; B63B 3/14; B63B 21/507; B63B 2035/4466; B63B 35/44

(57) ABSTRACT

The invention comprises a hydraulic pump, wherein wave energy is used to pump a fluid. The apparatus utilizes the oscillation of the free surface of a water column within a moon pool on a floating vessel to lift a floating pump unit. After reaching a peak elevation induced by a passing wave, the gravitational forces on the floater pressurizes and moves a fluid using structurally linked pistons within fixed cylinders on the vessel during the downward return motion of the floater. The pressurized fluid can then be used in a variety of applications including the generation of electricity via hydroelectric turbines.

### FIELD OF THE INVENTION

The present invention relates to energy conversion and electrical power generation. More particularly, the present invention relates to ocean wave powered hydraulic pumps and hydroelectric power production.

### SUMMARY OF THE INVENTION

Embodiments of the present invention include a unique floating ship-type apparatus with the means to capture a portion of the energy within a passing wave to pump a fluid for the use of electrical generation or other useful process. The apparatus utilizes the vertical oscillation of the free surface of seawater within a moon pool (an open column within the structure of a vessel open to the sea below and atmosphere above) to lift a floating pump unit as wave crests pass by the ship. The floating pump unit includes structurally linked pistons that translate within fixed piston cylinders on the vessel. As the wave lifts the floating pump unit, a low pressure fluid fills the volume of the piston cylinders via check or single-direction valves. After a wave crest passes by the moon pool, the water column within the moon pool drops. Then the gravitational potential energy of the floating unit applies pressure to the fluid within the piston cylinders and forces the fluid through conventional hydroelectric turbines and generators as described within the preferred embodiment of the design. As the fluid is cleared from the piston cylinders, the floating unit drops vertically until it is again supported by seawater via buoyancy. The fluid exiting the turbines is then returned back to the piston chambers via hydrostatic pressure to repeat the continual process powered by ocean waves.

### BACKGROUND OF THE INVENTION

Moon pools have been used on offshore construction and research vessels. Previously, the oscillation of waves within these moon pools has been seen as detrimental and efforts have been made to dampen the effect of oscillating water levels within such moon pools. In contrast, embodiments of the present invention make advantageous use of this oscillation.

U.S. Pat. No. 8,745,981 and Published App. No. 2014/0035286 teach the use of wave activated power generation systems that use the linear action of a float to directly drive the rotary action of a shaft through mechanical linkages similar to a rack and pinion.

U.S. Pat. Nos. 8,841,792 and 7,830,032 teach the use of a water column where the top is sealed to compress air and power an air turbine. While these inventions use an at sea oscillating water column, they do not use a float to pump a fluid.

U.S. Pat. Nos. 7,956,479, 6,930,406 and 8,628,303 and U.S. Published App. No. 2007/0130929 each disclose float based systems that are either pier mounted or anchored to the sea floor. In order to pump a fluid, such an apparatus must possess ample inertia so as to provide an equal and opposite force while pumping. These prior inventions use a fixed structure or anchoring to the sea floor as means to provide required inertia.

U.S. Published App. No. 2008/0018114 teaches a ship where floaters positioned off the sides of the vessels pump a fluid to a turbine via mechanical levers and linkages.

While other devices have been developed with the goal to capture and convert wave energy, embodiments of the present invention have several distinct advantages over previous concepts. For example, in contrast to previous systems using mechanical linkages, the apparatus described herein uses waves to create a potential energy whereby the weight of a floater pumps a fluid. Because the pressurization of the water driven to the turbines is purely gravity induced, there is no mechanical loss of energy through linkages or rotating components and the pressure loss of the fluid in route to the turbine is minimal.

Known devices may use a fixed structure or anchoring to the sea floor, while embodiments of the present invention may use the inertia of a large floating vessel. This provides an added benefit as electricity can be generated at the on-site platform rather than pumping fluid a long distance to turbine-generators on land.

Still other known devices pump on the upstroke with swell action or are bi-directional. Instead, embodiments of the present invention pump using gravity on the down stroke. Because a passing wave shall elevate a plurality of floaters and a lag time is expected in transferring fluid through a turbine, the present invention is able to develop a constant pressure, which acts as a reservoir to reduce impulses on the system.

Further, other known devices expose the working mechanism to potential damage from wind, waves or debris. Embodiments of the present invention may be configured to protect the working mechanism from the lateral and slamming forces of waves in the open sea and is thus more effective at capturing the pure vertical action of a passing wave.

Embodiments of the present invention offer additional advantages. First, the present invention may be a single unit capable of producing a large quantity of power if situated in the proper ocean environment whereas known devices often consist of numerous small units aimed at capturing the energy from tidal waves. These typically produce little electricity per individual unit and are spread out over large swaths of shoreline with many cables extending to one another or back to land. This can be undesirable to local residents and wildlife. The apparatus described herein would typically be situated a significant distance offshore due to the vessel draft and would only require a single electrical cable extending to a substation on land.

Next, embodiments of the present invention may comprise a significant number of components that are regularly found on existing ships, which can prove beneficial over an innovative concept where feasibility and constructability are unknown. The construction of a vessel in accordance with the present invention could be very similar to that of an oil tanker but simpler to a degree. Because the vessel is intended to be stationary it can be made “boxier” with constant angles and facets at the forward and aft end rather than having complex curvature and bulbous bows used to reduce the drag of mobile vessels. Also, for a stationary setting, there would be no need for a propulsion system, which reduces cost in comparison to an oil tanker.

The system described in this application could be used to generate and sell electricity to customers, store energy aboard the vessel or propel a ship at sea. The description of the preferred embodiment herein will emphasize the stationary setting where a vessel is moored at sea and transmits electricity to shore via subsea cables. A mobile version would likely consist of a scaled-down version of the pumping process where less energy and thus less pumping units are required to create propulsion and a portion of the ship's configuration could be used for other purposes such as equipment, cargo or passengers.

It is envisioned that a vessel consistent with the invention could be very large and of scale equal to that of a VLCC (Very Large Crude Carrier) oil tanker or FPSO (Floating Production Storage Unit) used in the offshore oil industry. In this scenario, this ship could be outfitted with 50-100 moon pool pumps and multiple hydroelectric turbine-generators. It is estimated that a ship of this size, placed in the proper ocean environment, could supply the electric demand of 50,000 to 200,000 customers, cost little more than a new VLCC oil tanker, store energy when electric demand is low and produce zero pollution during operation.

### BRIEF DESCRIPTION OF THE DRAWINGS

The following figures illustrate certain embodiments of the present invention.

FIG. 1 is an elevation, cross-sectional view of the apparatus in a still-water static state at the vessel centerline;

FIG. 2 is an elevation, cross-sectional view of the apparatus with a passing wave at the vessel centerline;

FIGS. 3A-3C present top and side views of a single pump unit;

FIG. 4 is a transverse, cross-sectional view of the apparatus showing moon pools, looking forward;

FIG. 5 is a transverse, cross-sectional view of the apparatus showing pump compartments, looking forward;

FIG. 6 is a plan view of the apparatus;

FIG. 7 is a plan view of high pressure and low pressure hydraulic lines with other components removed for clarity;

FIG. 8 is a plan view of the vessel baseline to show moon pool locations

FIG. 9 is a magnified elevation, cross-sectional view of FIG. 2 with additional detail;

FIG. 10 is a magnified plan view of FIG. 6 with additional detail;

FIG. 11 is a magnified plan view of FIG. 7 with additional detail;

FIG. 12 is a perspective view of a single pump unit;

FIG. 13 is a perspective view of the apparatus looking forward, port and down;

FIG. 14 depicts the same view as FIG. 13 but with a passing wave;

FIG. 15 is a perspective view of the apparatus looking aft, port and down with a passing wave;

FIG. 16 is a perspective view of the apparatus with a passing wave looking up, aft and port from beneath the free surface of the sea to display the submerged portion of the apparatus;

FIG. 17 is a perspective view looking aft with a passing wave;

FIG. 18 is a perspective view of the vessel structure looking aft, port and down with all other components removed for clarity;

FIG. 19 is a perspective view of the pump units looking aft, port and down with all other components removed for clarity;

FIG. 20 is a perspective view of the high pressure fluid piping system looking aft, port and down with all other components removed for clarity;

FIG. 21 is a perspective view of the low pressure fluid reservoirs and piping looking aft, port and down with all other components removed for clarity;

FIG. 22 is a perspective view of the entire high and low pressure fluid circuit looking aft, port and down with all other components removed for clarity;

FIG. 23 depicts a combined perspective view of the components in FIG. 19-FIG. 22 with all other components removed for clarity;

FIG. 24 is a magnified perspective view of a portion of the apparatus looking down at the main deck showing the upper portion of the pump units and piston cylinders;

FIG. 25 is a cut-away, perspective view looking forward, port and down in way of moon pools;

FIG. 26 is a cut-away, perspective view looking forward, port and down in way of pump compartments;

FIG. 27 is a cut-away, perspective view of the centerline moon pools and pump compartments looking aft, port and down;

FIG. 28 is a perspective view of a single pump unit in an alternate embodiment of the invention;

FIG. 29 is a perspective view of the pump units in an alternate embodiment of the invention looking aft, port and down with all other components removed for clarity;

FIG. 30 is a perspective view of the high pressure fluid piping system in an alternate embodiment of the invention looking aft, port and down with all other components removed for clarity;

FIG. 31 is a perspective view of the low pressure fluid reservoirs and piping in an alternate embodiment of the invention looking aft, port and down with all other components removed for clarity;

FIG. 32 is a perspective view of the entire high and low pressure fluid circuit in an alternate embodiment of the invention looking aft, port and down with all other components removed for clarity;

FIG. 33 depicts a combined perspective view of the components in FIG. 29-FIG. 32 with all other components removed for clarity;

FIG. 34 is a cut-away, perspective view looking forward, port and down in way of moon pools in an alternate embodiment of the invention;

FIG. 35 is a cut-away, perspective view looking forward, port and down in way of pump compartments in an alternate embodiment of the invention;

FIG. 36 is a cut-away, perspective view of the centerline moon pools and pump compartments looking aft, port and down in an alternate embodiment of the invention;

### DETAILED DESCRIPTION OF THE INVENTION

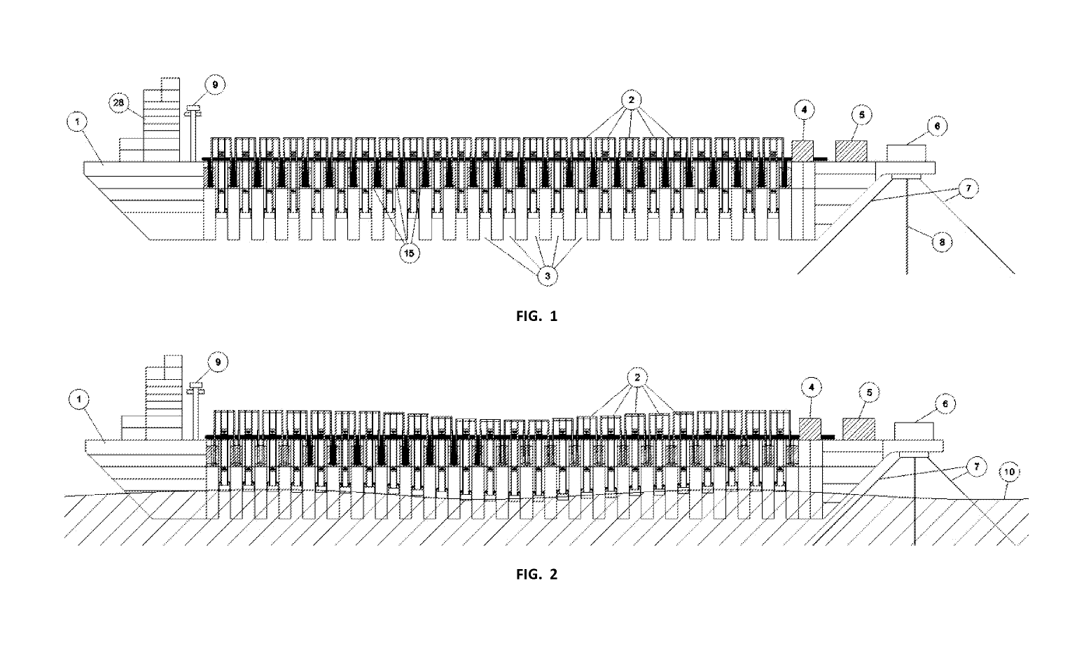

Referring now to embodiments of the invention in more detail, as illustrated in FIG. 1 and FIG. 2, the apparatus comprises a floating vessel 1, multiple pump units 2, multiple moon pools 3, hydro-electric turbines 4, electrical module 5, turret 6, mooring lines 7, subsea electrical cables 8 and gantry crane 9. Throughout this application, the words “vessel” or “ship” may be used to describe embodiments of the present invention. However, it should be noted that any appropriate platform or other support structure may be used, including ships, boats, hulls, watercraft, buoys, floats, barges, modified offshore oil platforms or the like. FIG. 1 is illustrated with the pumping units 2 in a stationary position as may occur in a calm sea. FIG. 2 is illustrated with a passing wave 10 to demonstrate the vertical pumping action.

The apparatus depicted in FIG. 1 and FIG. 2 may capture a portion of the energy within a passing wave 10 and convert it to electrical energy via hydroelectric turbines and generators. The apparatus would typically be anchored to the sea floor using mooring lines 7 connected to a rotating turret 6 at the bow of the ship-type floating vessel 1. This configuration allows the floating vessel 1 to weather-vane or rotate such that the bow is continuously oriented towards oncoming waves 10. Alternatively, the apparatus may be secured by other means. The mooring system for a fixed position platform could be altered from the single-point turret application to multi-point mooring extending from several locations on the ship. For example, if the apparatus were positioned in a location where the oncoming waves arrive from a consistent direction, the rotating turret may not be necessary. In a further alternative, the single-point mooring turret application could be repositioned to a location adjacent to the midship if it is found that beam seas will create an increase in pumping action and thus are preferred rather than head seas.

The apparatus may be constructed to contain numerous moon pools 3. A single pump unit 2 may be positioned in each moon pool. Alternatively, multiple pump units could be positioned in each moon pool. As a wave crest and trough passes by the vessel, the dynamic pressure below the floating vessel 1 will fluctuate. This in turn causes the free surface water level within the moon pools 3 to oscillate in a vertical motion. Each pump unit 2 is free to lift within a moon pool 3 under the influence of buoyant forces as the water level rises. After a pump unit 2 has reached its peak elevation for a given passing wave 10 the water level drops within the moon pool 3 and the buoyant forces on the pump unit 2 are reduced or eliminated entirely. The gravitational force exerted on the pump unit 2 causes the pump unit to drop relative to the hull of the ship. As the pump unit 2 drops within the moon pool 3, the relative movement between the two components is used to pressurize and push a fluid through piping to drive a turbine 4 and ultimately create electricity with the use of generators. The generated electricity is then routed, connected and monitored within an electrical module 5 and transmitted off the apparatus via subsea electric cables 8 through the turret 6 or other appropriate electrical connection. A gantry crane 9, which may be used for maintenance or repairs, is also depicted. Such a crane may translate forward and aft via tracks on the outboard extents of the floating vessel 1.

The electrical output could be transferred to customers on land or at sea for the use of offshore industry. When electrical demand is low, energy could be stored as compressed air or within battery packs on board the ship for later use or to power auxiliary systems on the floating vessel 1.

An alternative configuration could be established without the need of a turret 6, mooring lines 7 or subsea cables 8. In one such embodiment, the vessel may be positioned by the use of electrically or otherwise powered drive propellers. This configuration may allow the vessel to be mobile, which would allow the vessel to move to positions of higher wave action or to move in order to avoid damage from storms. Embodiments of the present invention could also be used to provide some or all of the motive power for transportation vessels. In this mobile scenario, electrical demand may be lower and, as such, fewer moon pools 3 and pump units 2 would be required. Therefore, more ship arrangement space would be free for cargo, equipment or passengers.

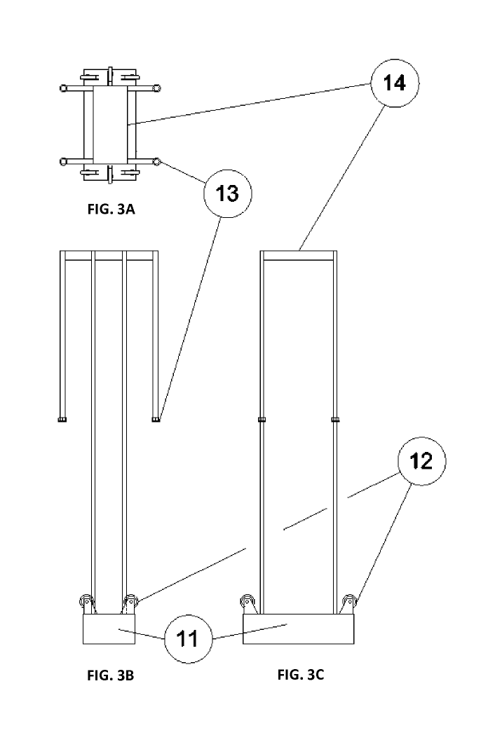

Views of a single pump unit 2 are shown in FIGS. 3A-3C including a plan view (top down), elevation (looking to port-side), and forward view (looking toward the bow or turret). FIG. 3 illustrates the major sub-components of a pump unit including the floater box 11, several guide wheels 12, pistons 13 and structural assembly 14. As illustrated, the pump unit includes four pistons 13, but more or fewer could be used as necessary. In the illustrated embodiment, each pump unit 2 is rigid and as such all components translate vertically together as a single unit.

The pump unit 2 in FIG. 3 extends up and above the main deck 29 via the structural assembly 14. The pistons 13 then penetrate back down through the main deck into pump compartments 15 fore and aft of the moon pools 3 to pressurize water transferred to the turbines 4. The guide wheels 12 are used to prevent slamming of the floater box 11 into the moon pool 3 boundaries that could otherwise be caused by the sloshing of the seawater within the moon pools 3. The guide wheels will also reduce racking effects on the pistons 13 by stabilizing the pump unit 2 within the moon pool 3. Alternatively, the guide wheels on the floater boxes of the pump units may be replaced by a vertical track, and the pump unit could translate vertically along this track. The pump unit may be reinforced with pipe members, trusses or other reinforcing members to supply the necessary strength for pumping

In other embodiments, the piston cylinders could be situated within the moon pool compartments in a manner that does not impede the operational oscillation of the pump units. In this scenario, the pump units would not need to extend forward and aft above main deck to penetrate down into pump compartments. Furthermore, the pump units could be adjusted to have less than 4 pistons. For example, an alternate stopper mechanism arrangement above main deck could allow for a single piston and piston cylinder situated within the extents of a moon pool in line with the vertical centerline of the pump unit.

The weight of the entire pump unit and size of the floater box is designed to obtain a proper balance of mass and floating depth. With a larger pump unit weight, there is a greater pressure exerted on the fluid transferred to the turbine 4, which will create more electricity. However, a larger weight also increases the equilibrium draft of the floater box.

A minimal equilibrium draft of the floater box 11 within the moon pool 3 is desired so that after a wave crest has passed the water column within a moon pool 3 will drop and upward forces on the floater box are minimized or entirely eliminated. A reduction in upwards buoyancy forces means more gravitational force is transmitted through the pistons and more electricity is generated. In the embodiment as illustrated, the floater box is 10×5 meters (m) and weighs 75 metric tons (mT). This mass and geometry requires a seawater depth of less than 1 m to obtain static equilibrium.

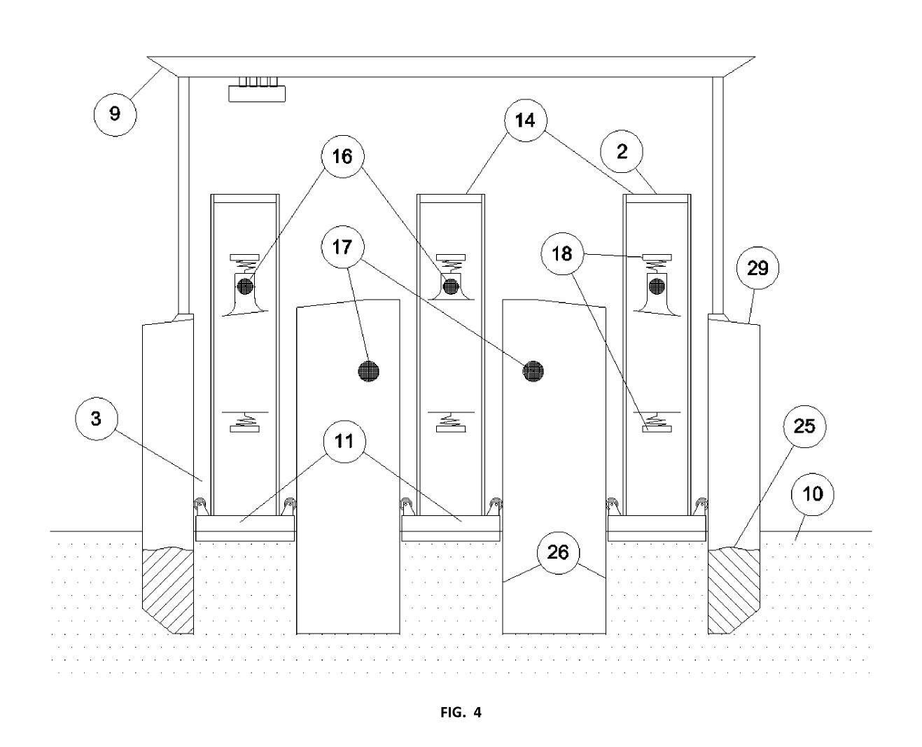

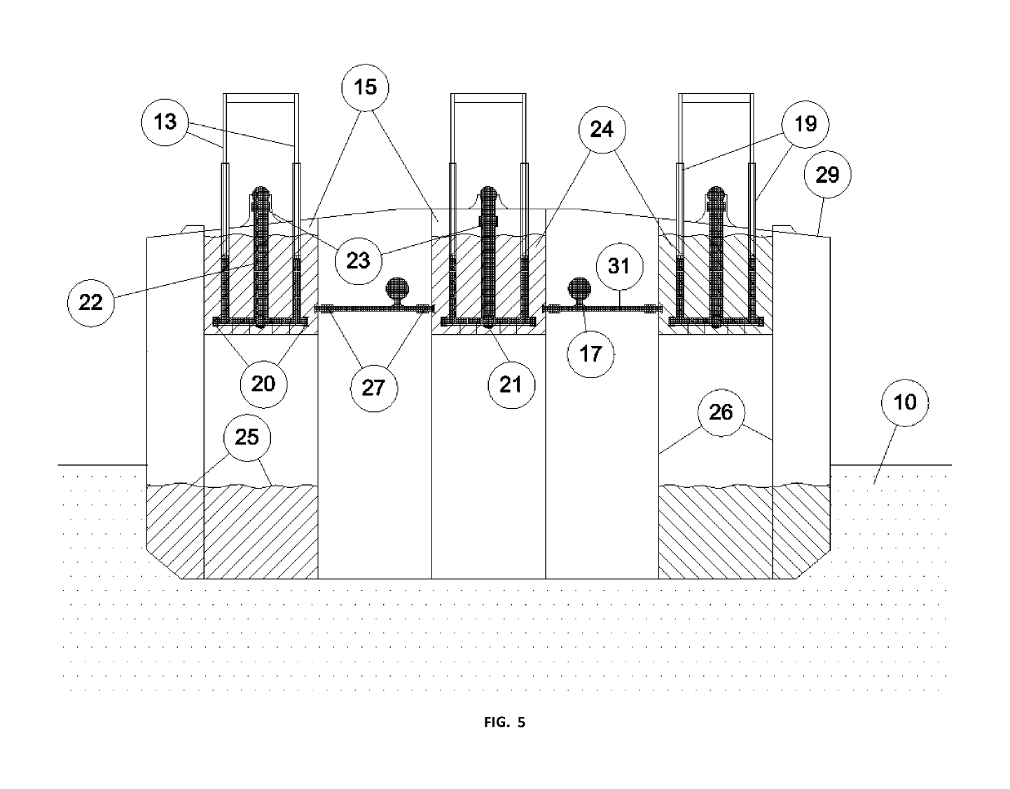

Transverse cross section views of the apparatus, including moon pools 3 and pump compartments 15, are shown in FIG. 4 and FIG. 5 respectively. In both figures, three individual pump units 2 and associated components are shown; one on vessel portside, one on vessel centerline and one on vessel starboard side. However, it will be understood by one of ordinary skill in the art that more or fewer pump units and moon pools could be used. FIG. 4 illustrates pump units 2 floating within the moon pool 3 within which the seawater free-surface oscillates vertically with passing waves 10. Also shown in FIG. 4 are the high pressure supply lines 16 above main deck 29, low pressure return lines 17, pump unit stoppers 18 and the gantry crane 9 when positioned over pump units 2.

The pump unit stoppers 18 in FIG. 4 are designed to absorb shock and arrest the movement of the pump units 2 in extreme weather events so as to prevent damage to the apparatus. The gantry crane 9 could also be used to lift the pump units 2 in an elevated state against the bottom pump unit stoppers 18 where they could be pinned in place to secure the apparatus for an extreme weather event, repairs or transit. As shown in the illustrated embodiments, the pump unit can oscillate more than 6m in elevation without engaging the stoppers. Alternatively, the gantry crane and stoppers could be replaced with another appropriate device or system to secure the pump units as necessary.

FIG. 5 illustrates the pump compartments 15 situated forward and aft of each moon pool 3. Each pump compartment 15 contains piston cylinders 19, low pressure inlet check valves 20, high pressure outlet check valves 21, high pressure uptake lines 22, high pressure main deck check valves 23, and an accumulation of low pressure fluid or low pressure static head 24. In both FIG. 4 and FIG. 5, the moon pools 3 and pump compartments 15 are bounded by water-tight structural bulkheads 26. Water ballast 25 is depicted as needed for the stability of the apparatus. The low pressure return lines 17 are shown to penetrate through the structural bulkheads into the pump compartments to replenish the low pressure fluid 31 and maintain the low pressure static head 24. The low pressure return lines may contain check and shut-off valves 27 where they enter each pump compartment 15 for maintenance or repair but otherwise no valves are needed on the low pressure return lines 17.

As the pump unit pistons 13 are lifted via the oscillation of seawater within the moon pools 3, the low pressure static head 24 within each pump compartment 15 is free to enter and fill the void in the piston cylinders 19 through a low pressure inlet valve 20. After the pump unit 2 reaches its peak elevation, the gravitational forces induce the downward movement of the pump unit pistons 13. The fluid in the piston cylinders 19 is thus pressurized and simultaneously closes the low pressure inlet valve 20. The fluid then must exit the piston cylinders 19 through the high pressure outlet check valves 21, move through the high pressure uptake lines 22, proceed through an additional high pressure main deck check valve 23 and continue through high pressure supply line 16 piping above main deck 29 to a turbine 4. Alternatively, the high pressure supply lines 16 could be routed below main deck 29.

Each pump compartment 15 may contain 4 piston cylinders 19 (except at the forward-most and aft-most pump compartments 15) of which two are linked to a pump unit 2 forward of the pump compartment and two are linked to a pump unit 2 aft of each pump compartment 15. In this embodiment, two separate high pressure outlet check valves 21 are necessary before the 4 piston cylinder 19 lines merge into a single high pressure uptake line 22 per pump compartment 15. The reason for this is so that the high pressure fluid from one pump unit's 2 piston cylinders 19 cannot influence the movement of the other pump unit 2 within the same pump compartment 15. The additional high pressure main deck check valves 23 above or just below main deck are not necessary for operation but permit easier access to close the output of a single pump compartment whether for maintenance or repair.

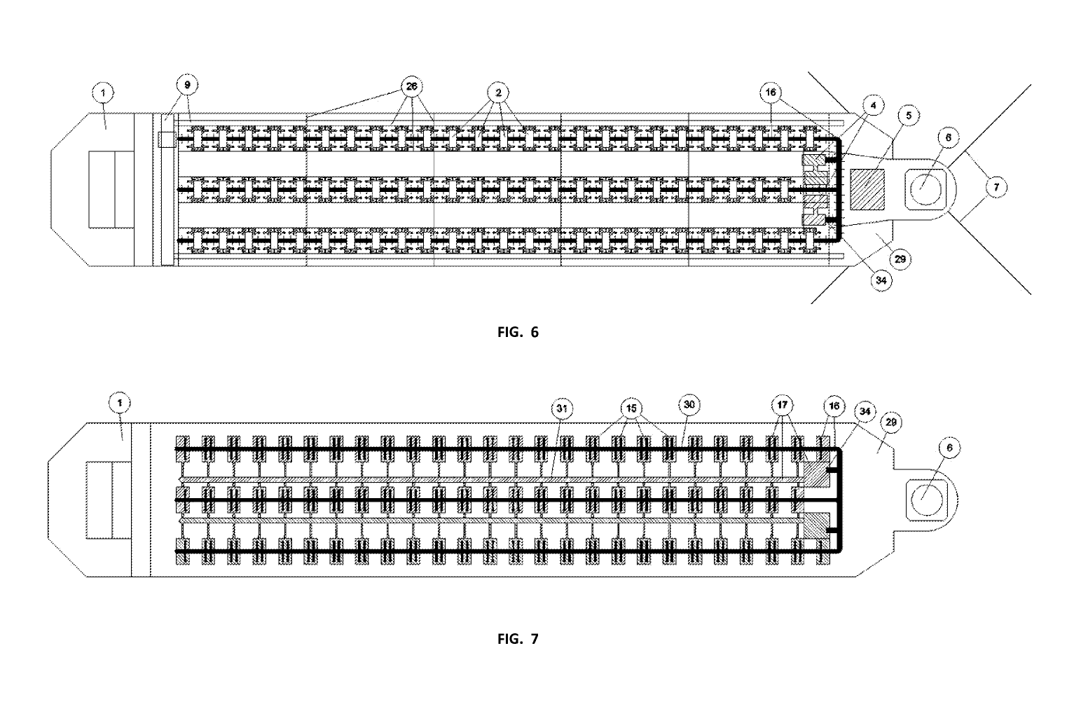

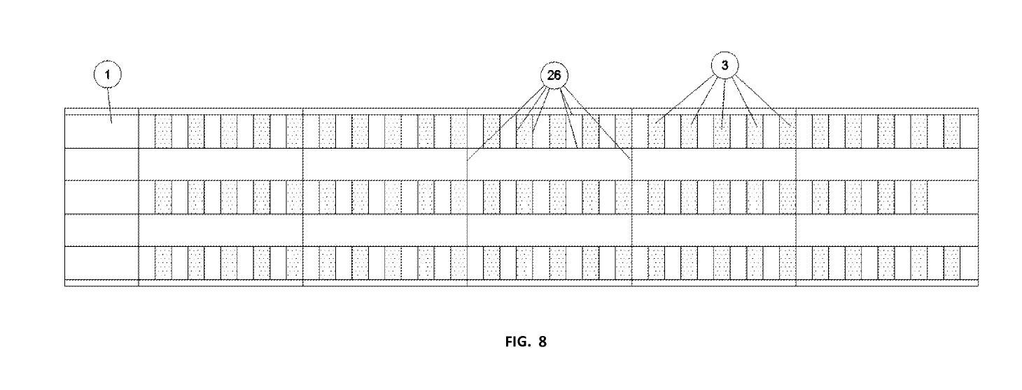

FIGS. 6-8 illustrate top down views of an embodiment of the apparatus with the forward end or bow of the ship to the right side of the page. FIG. 6 displays the hydroelectric turbines and generators 4 on main deck 29 towards the forward end of the floating vessel 1. Also shown is the electrical module 5, turret 6, mooring lines 7, pump units 2, high pressure water lines 16, water-tight structural bulkheads 26 below main deck and a gantry crane 9. FIG. 7 shows the floating vessel 1, high pressure water lines 16 and low pressure return lines 17 with all other components removed for clarity. FIG. 8 is a plan view of the floating vessel 1 at baseline or bottom plate to clearly show all the openings for moon pools 3 and water-tight structural bulkheads 26.

Referring to FIGS. 6-7, after the high pressure lines 16 reach and spin the turbines 4, the fluid exits the turbines 4 and drops below main deck 29 into tanks. All pump compartments 15 are interconnected and linked to the tanks of fluid exiting the turbines via free flowing low pressure return lines 17. In this manner, the pump compartments always contain ample water to continue the pumping process.

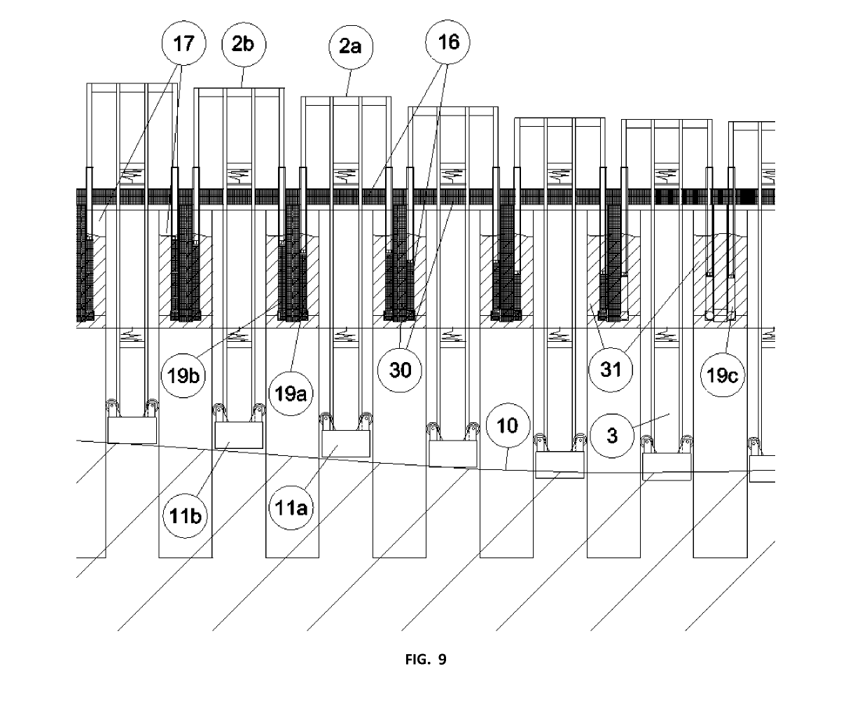

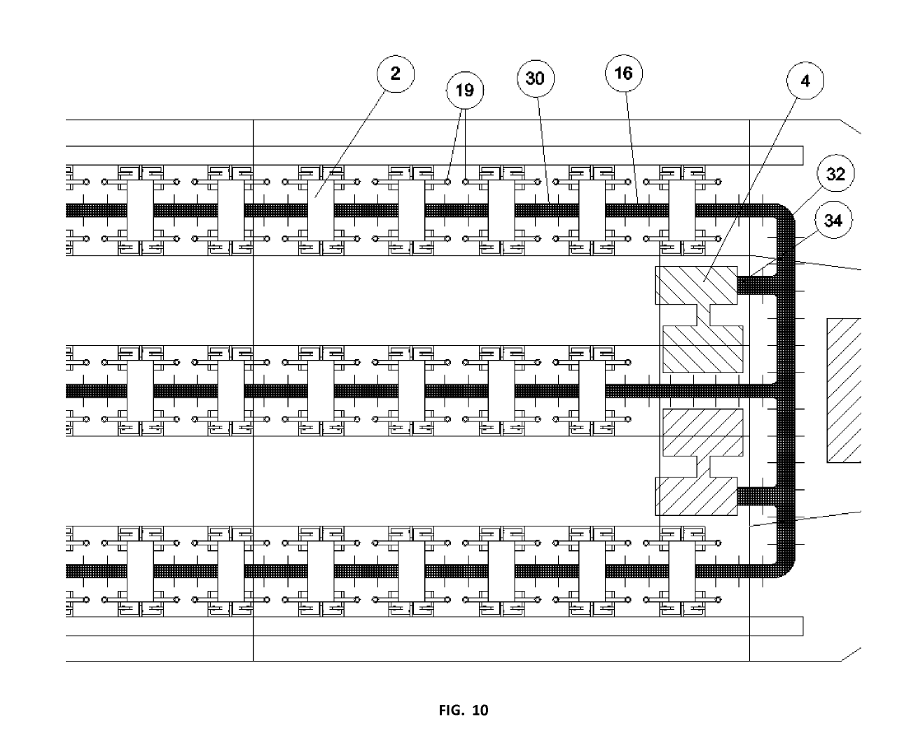

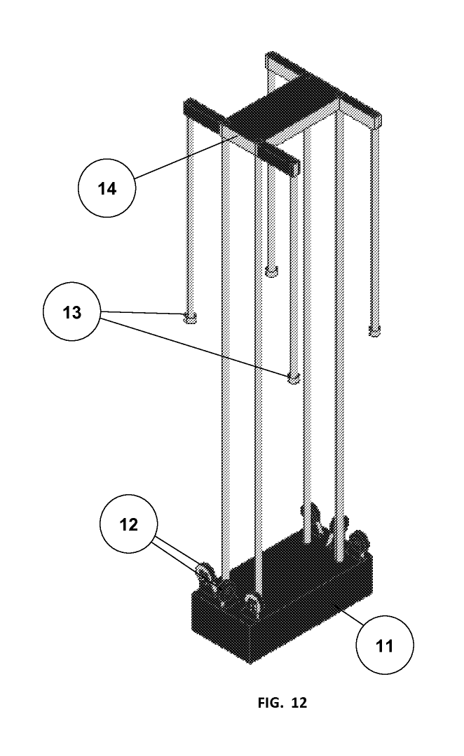

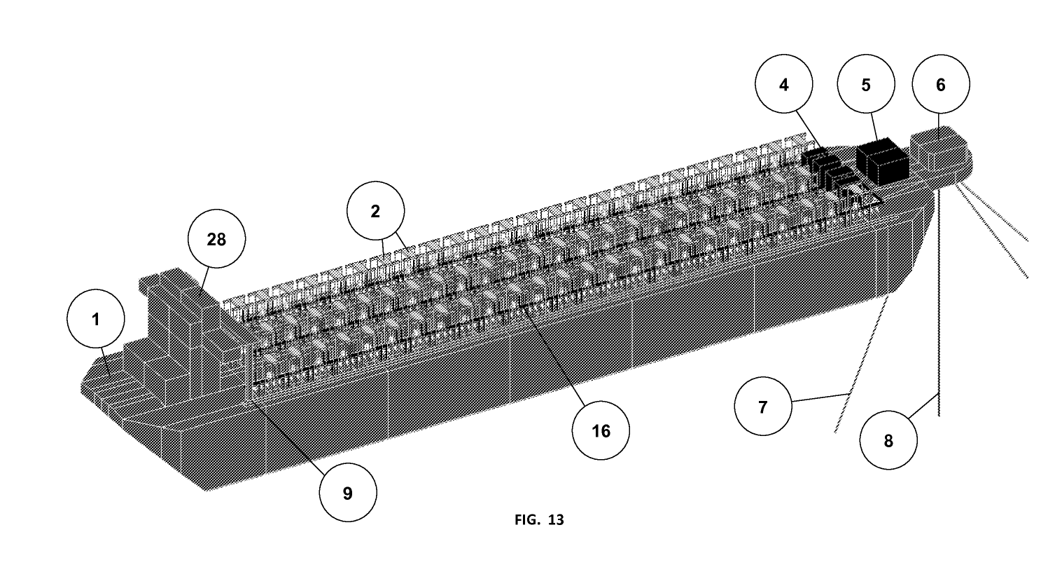

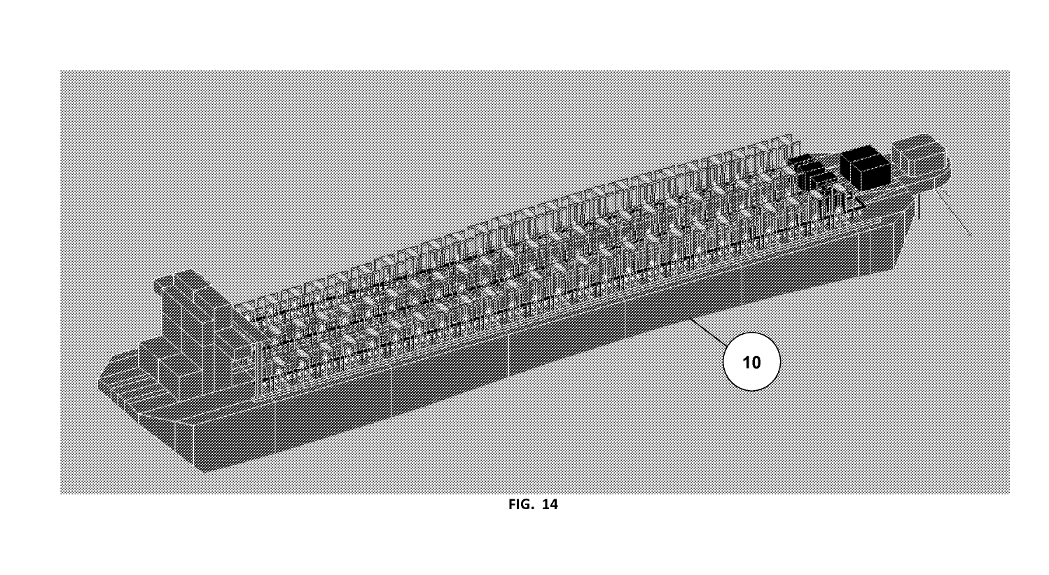

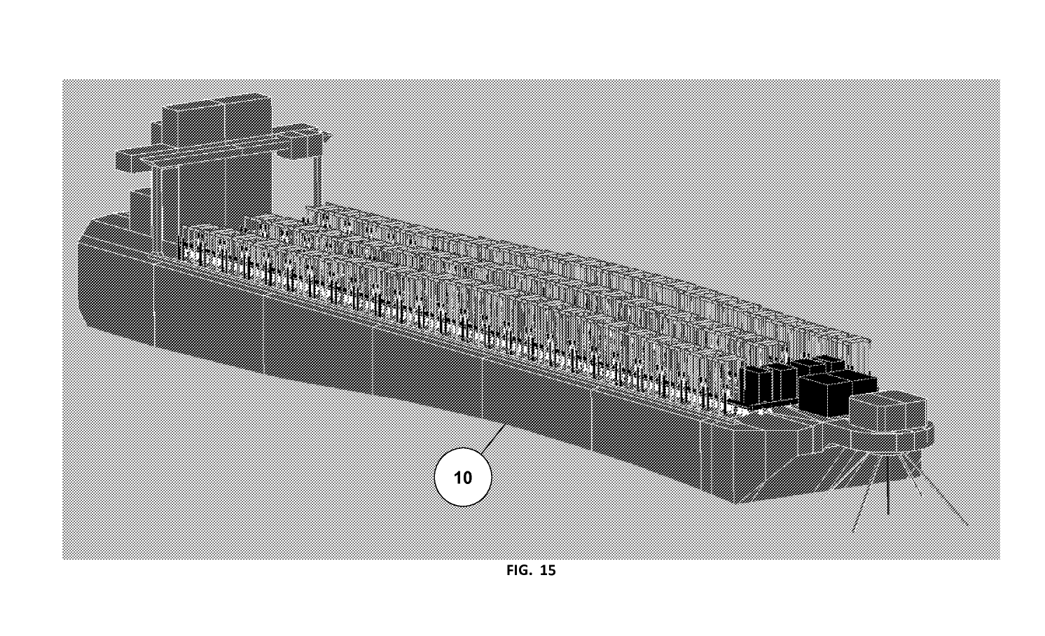

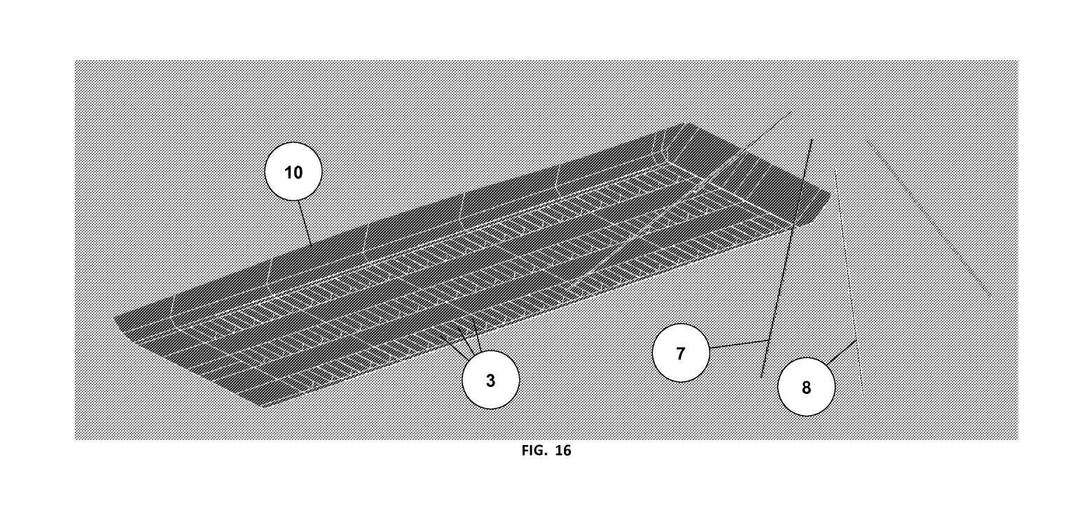

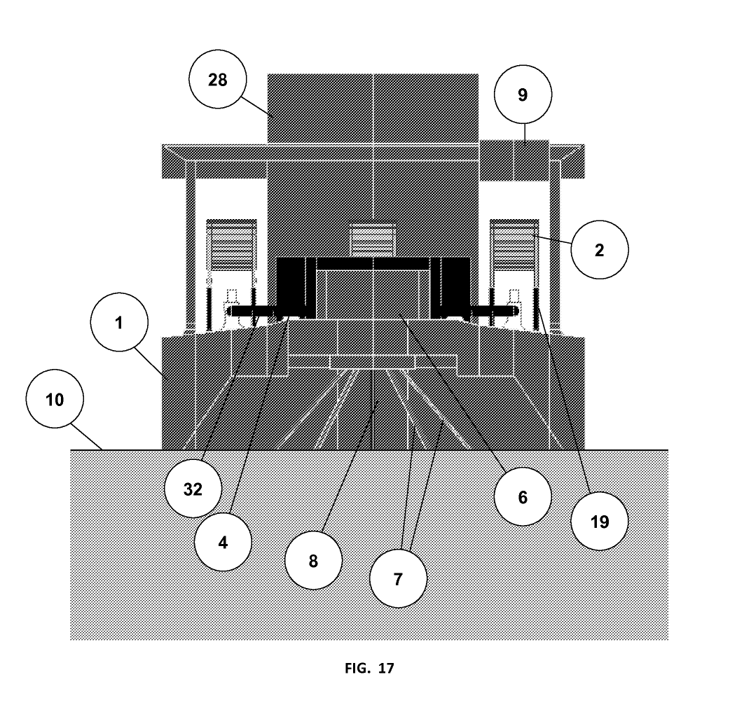

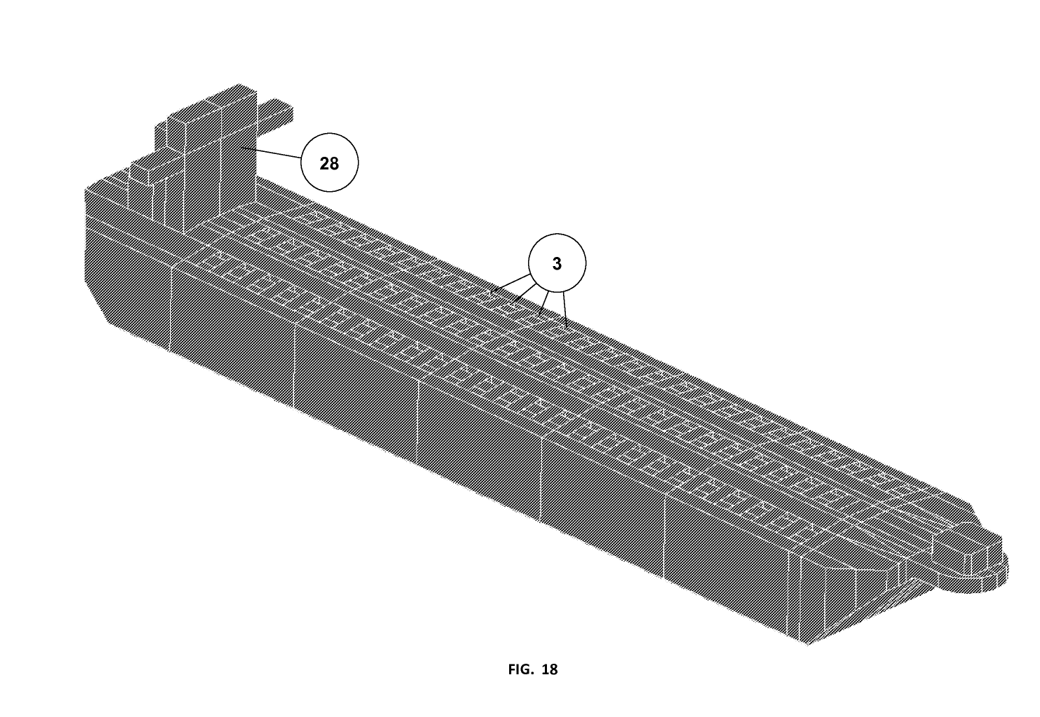

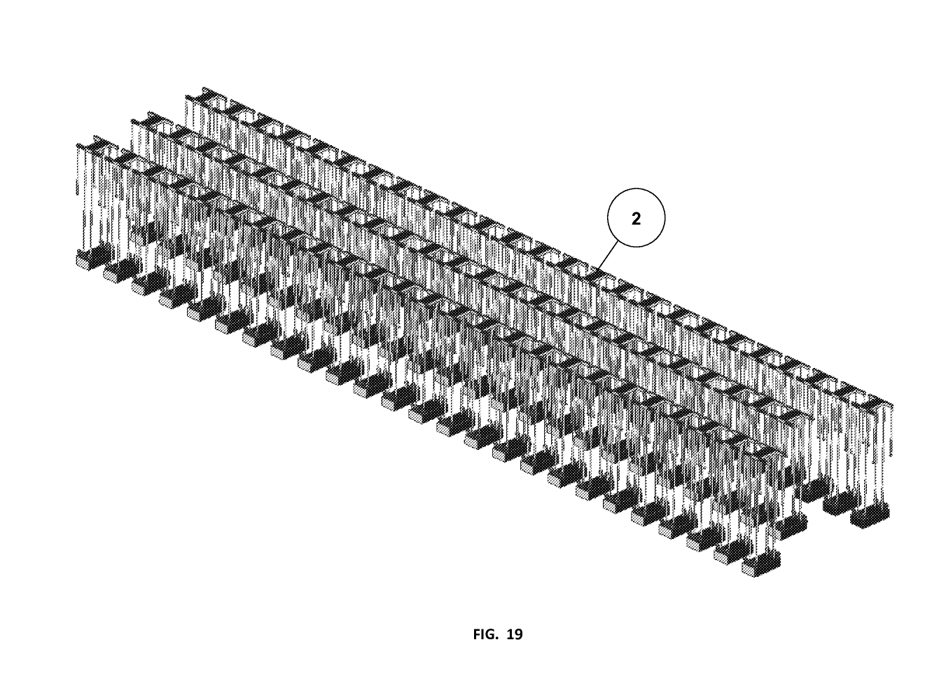

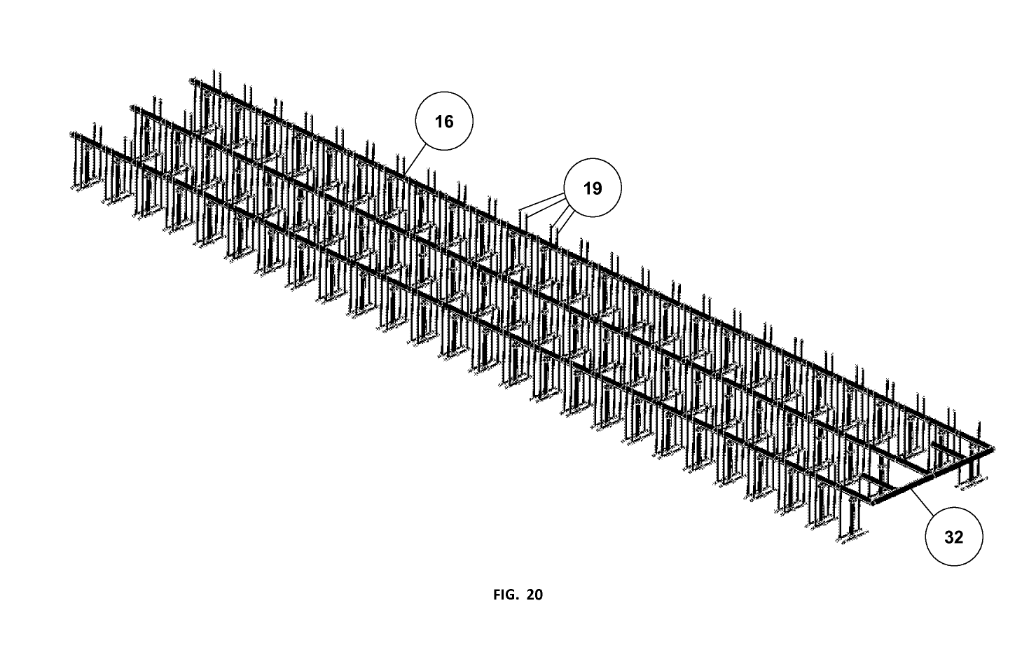

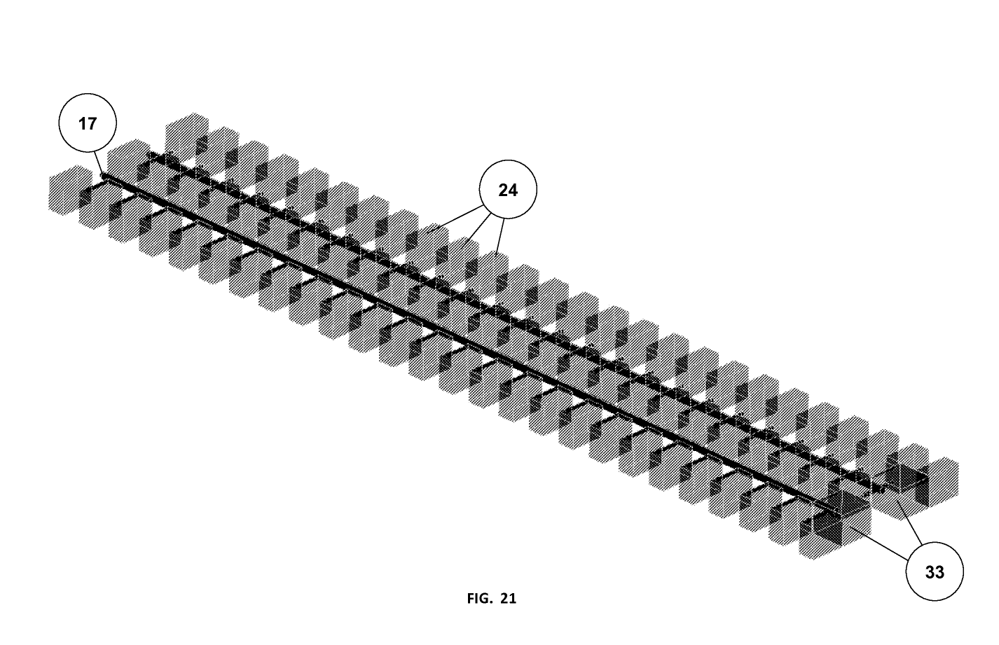

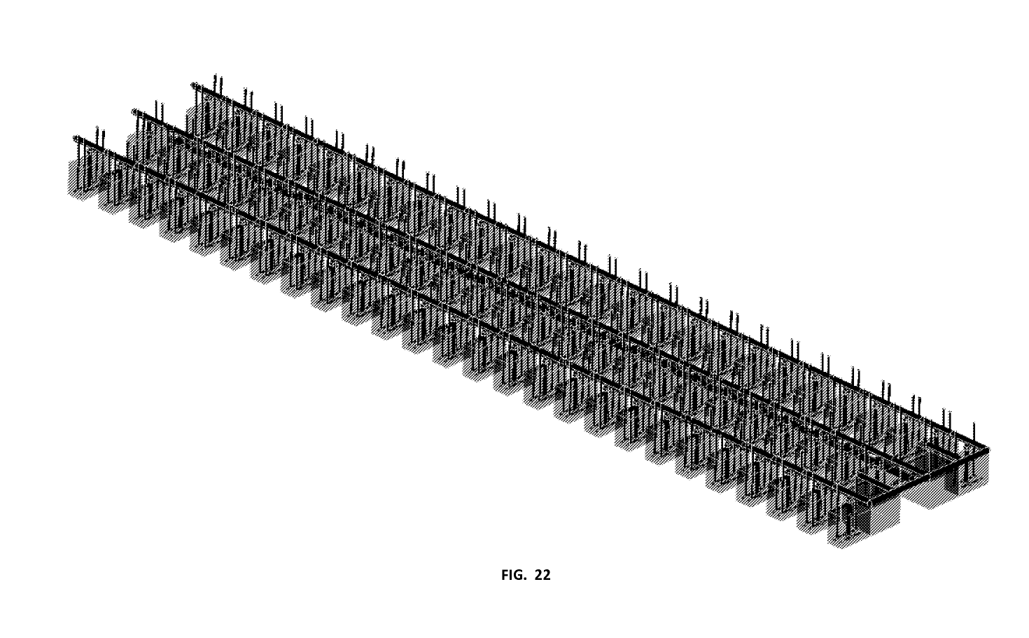

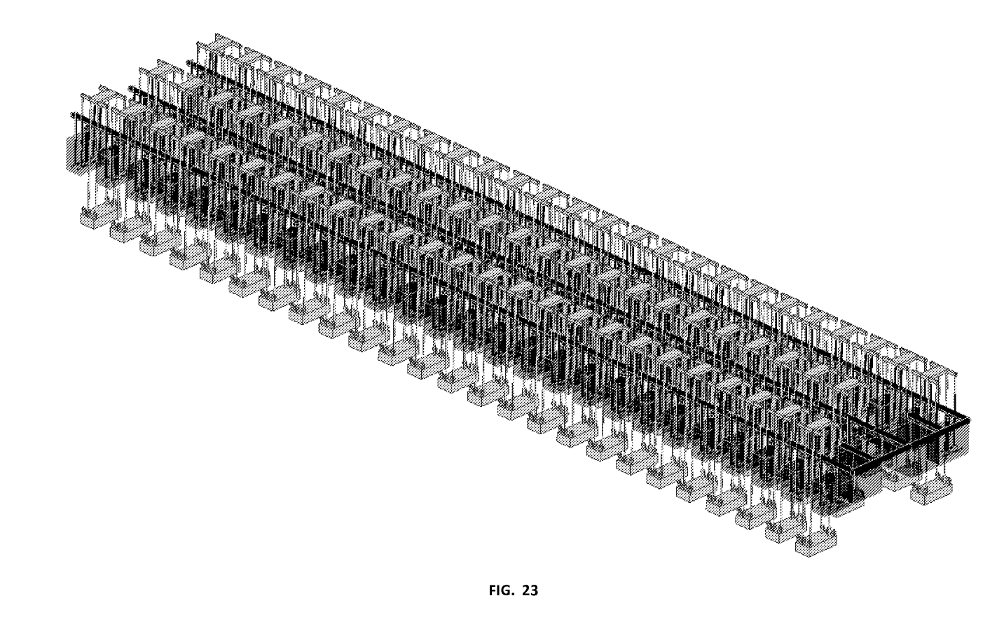

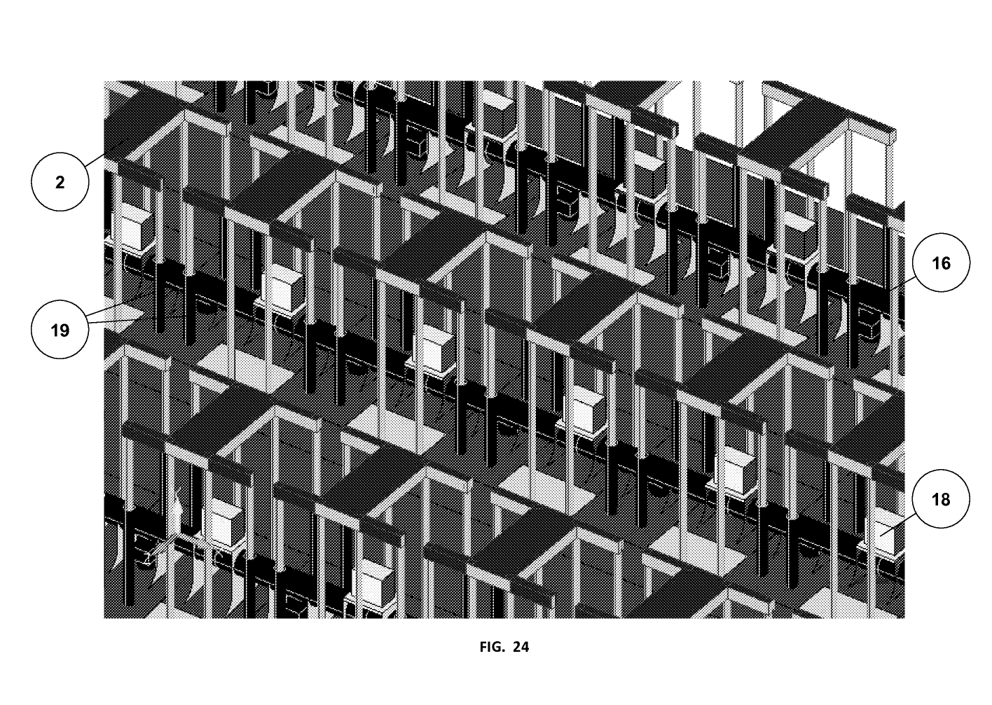

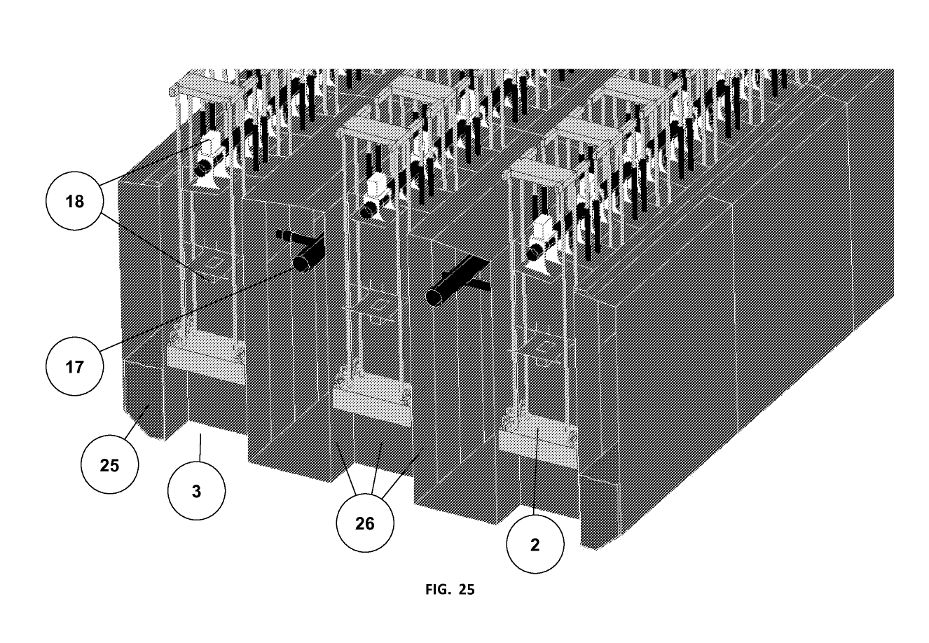

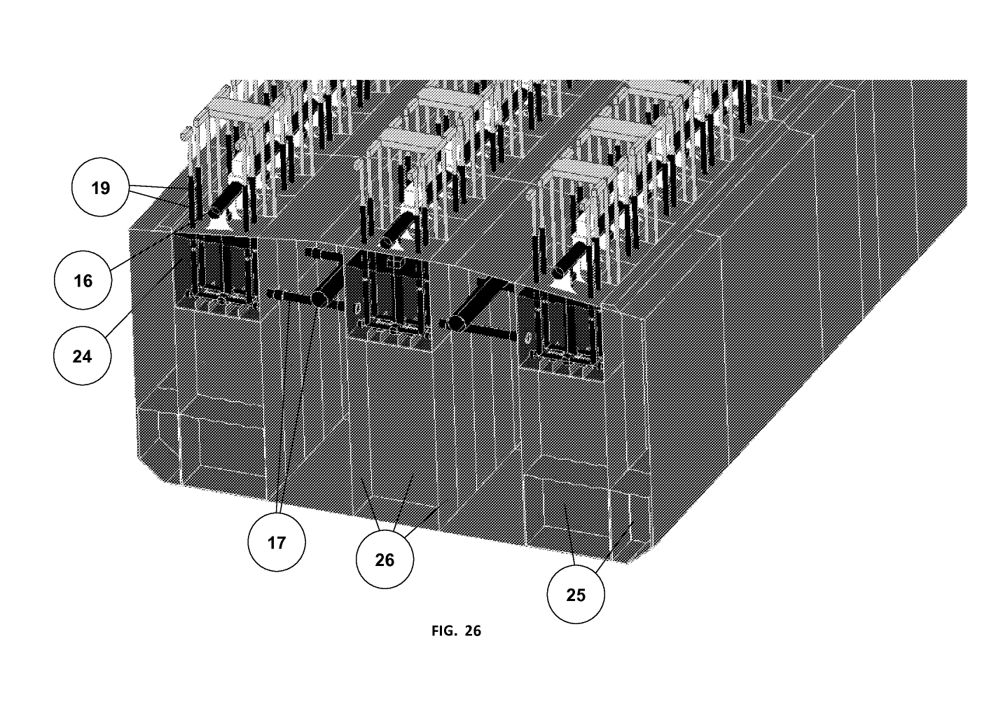

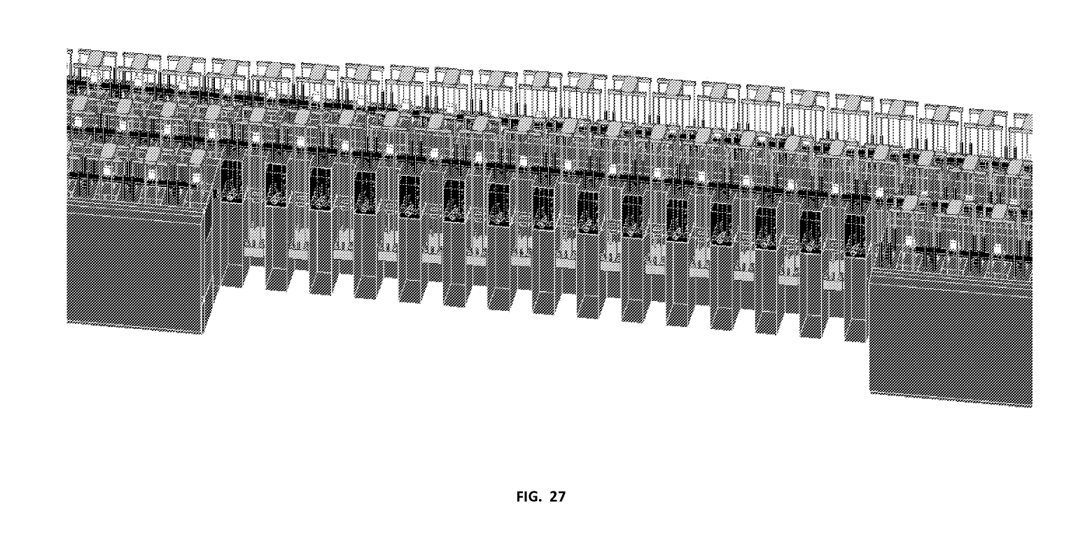

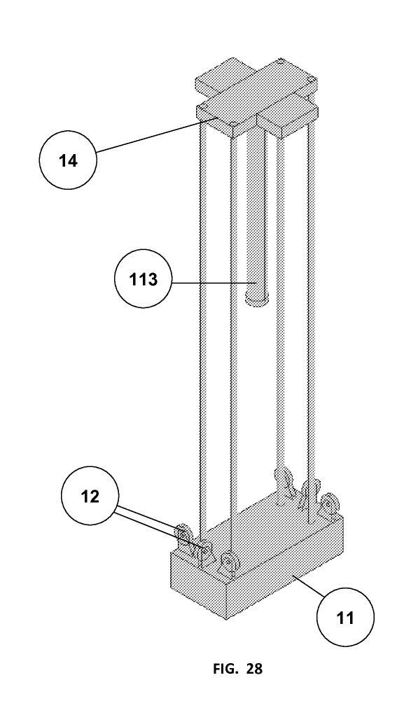

FIGS. 9-11 are magnified views of portions of FIG. 2, FIG. 6 and FIG. 7 respectively to provide additional detail. FIG. 12 through FIG. 27 provide corresponding perspective views to supplement the 2-dimensional drawings for clarity.

FIG. 9 illustrates the downward pumping action of the pump units 2 on the backside of a passing wave 10 (which is passing from right to left). It is expected that there will be lag in response due to the time required to force all the water out of the piston cylinders 19. Therefore, the pump unit 2 may at certain instances be completely suspended above the water within a moon pool 3, as is illustrated by float boxes 11a and 11b being suspended above the surface of the wave 10. As each float box 11a, 11b and its associated pump unit 2a, 2b descends under the force of gravity, water (or another appropriate hydraulic working fluid) is pressurized in piston cylinders 19a, 19b. The pressurized side of the circuit, including the pressurized fluid 30 within piston cylinders 19 and the high pressure supply lines 16 is represented as a cross-hatched pattern in the drawing. The low pressure side of the circuit 31 is illustrated by a hatched pattern.

It can be seen that the pump units toward the right side of the figure have just reached a buoyant state within the water of the moon pool to restart the pumping process with the next wave and therefore there is no high pressure fluid in these piston cylinders 19c. As the pump unit rises with the next wave, the piston cylinders will fill with the low pressure fluid 31 as the process continuously repeats.

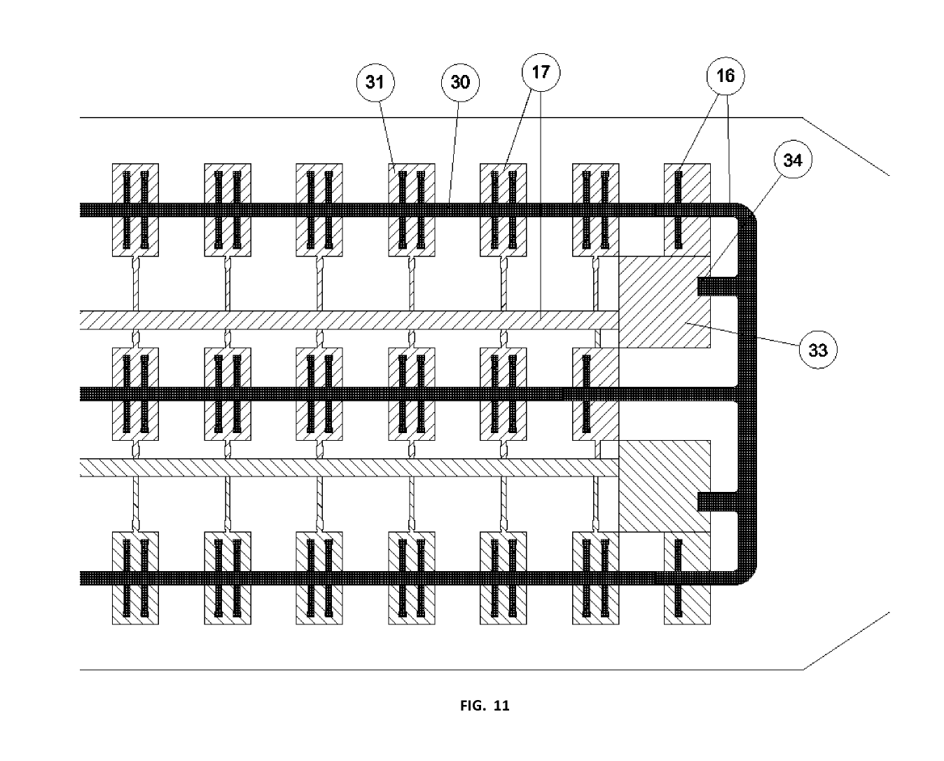

Within FIG. 7 and FIG. 11, the complete cyclic route of the fluid is depicted such that all high pressure fluid 30 leaving the piston cylinders 19 is pushed above main deck and to the forward end of the vessel where it makes a full 180° turn 32 before entering the turbines 4. After exerting force on the turbines, the water is returned to a low pressure state as it falls into a tank 33 below main deck. The water then flows freely back into the pump compartments where it will once again enter the piston cylinders to repeat the process. The illustrated embodiment shows two hydro-electric turbines 4 mounted at a forward end of the main deck. However, the number of hydro-electric turbines and their locations may be adjusted. For example, more or fewer turbines and generators could be used, and they could be placed below deck or at another part of the vessel. The 180° turn 32 of the high pressure fluid 30 is not necessary but appropriate for the configuration of the presented embodiment. If the turn creates a significant pressure drop, the turn could be eliminated with direct flow into the turbines. In any given configuration, the high pressure fluid lines 16 should be arranged such that flow from any given pump compartment 15 can be routed to any selected turbine 4 if other turbine(s) are taken out of operation for maintenance, repair, a period of calmer seas when fewer turbines are needed or any other reason. Therefore, a flow control valve 34 which can also shut off flow will be situated at the entry to each turbine 4.

The selection of turbines and generators will be highly dependent on possible variations within the design and operation environment. For example, for a given pump unit 2, an increase in piston cylinder 19 diameter will reduce the pressure at the turbine but increase flow rate. It is expected that either a Pelton of Francis hydroelectric turbine will be the optimum turbine type for this type of application. However, one of ordinary skill in the art will recognize that other appropriate turbines or generators may be used. The flow control valve 34 at each turbine can be dynamically adjusted for a proper balance of pressure and flow rate to account for variances in the operating environment of the sea. The description of certain embodiments has assumed the working hydraulic fluid to be water. However, any incompressible fluid is feasible with the use of the hydroelectric turbines. The system could potentially use seawater but it may prove beneficial to use freshwater to reduce the corrosion of piping and other components of the system. Because the fluid is completely recycled, there would only be limited losses through evaporation or spill over at the turbine exits or pistons. A desalination plant could be employed on the vessel to convert seawater to fresh water as needed.

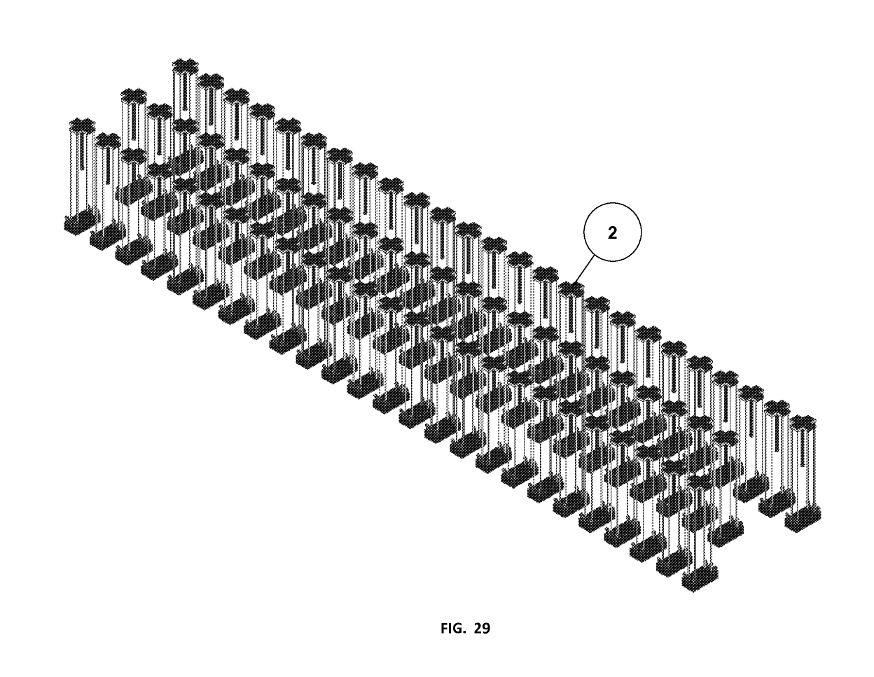

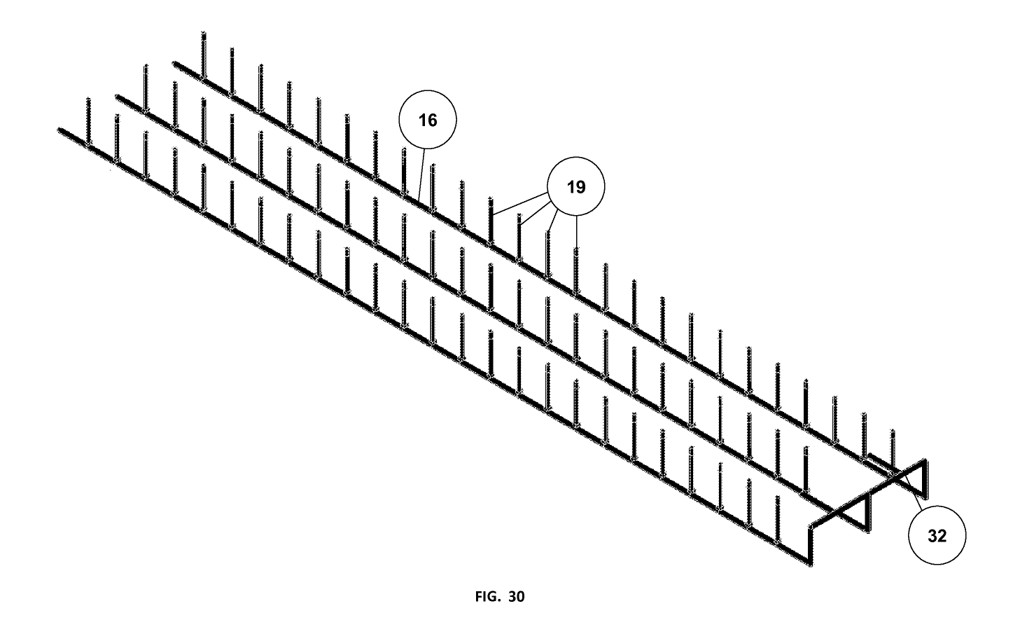

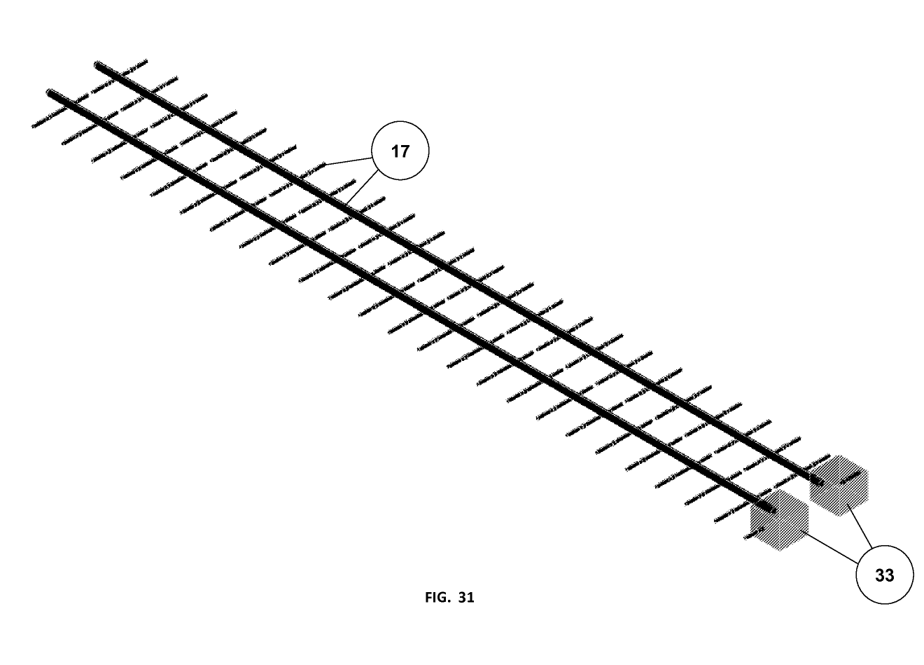

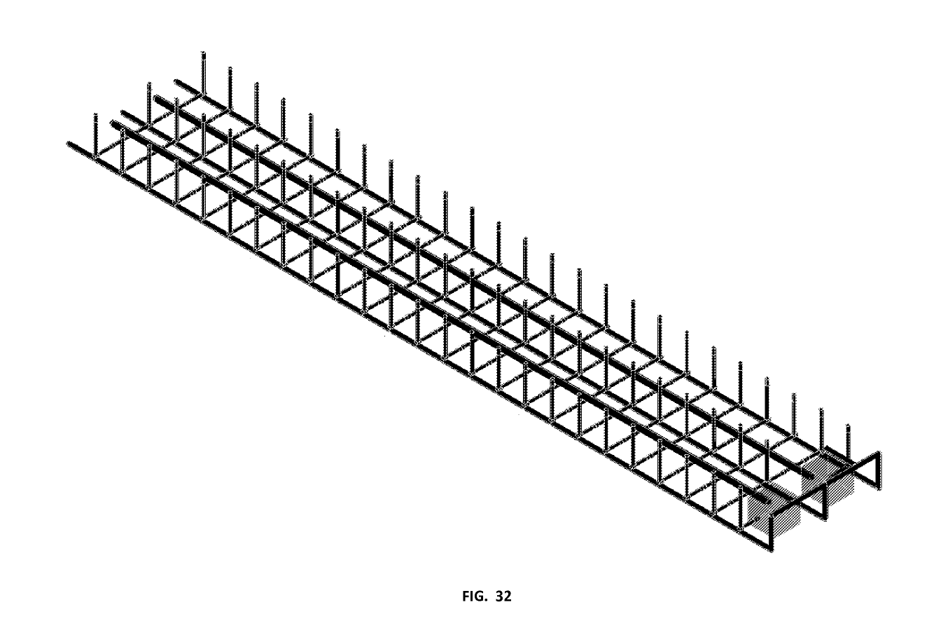

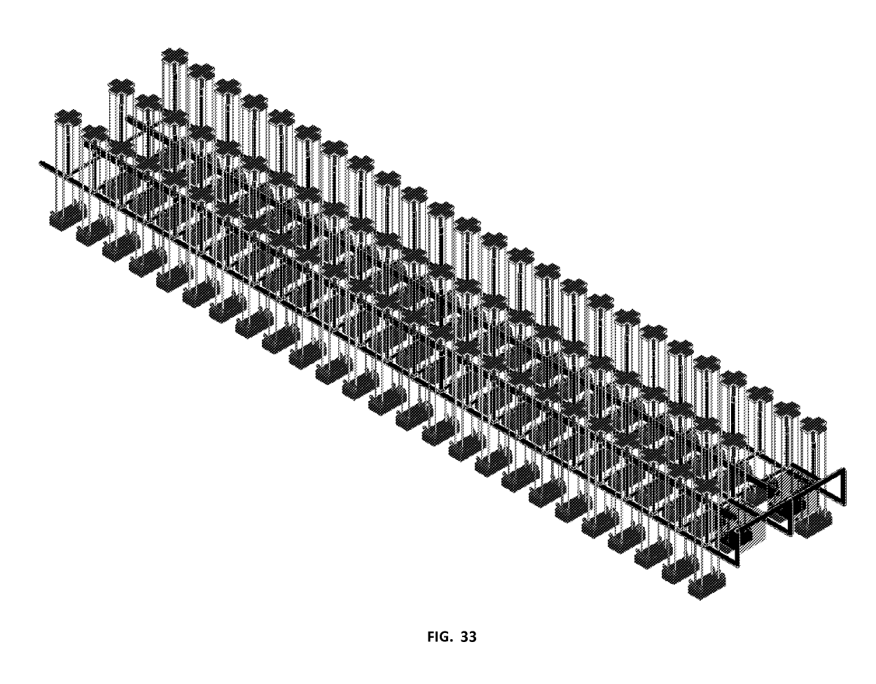

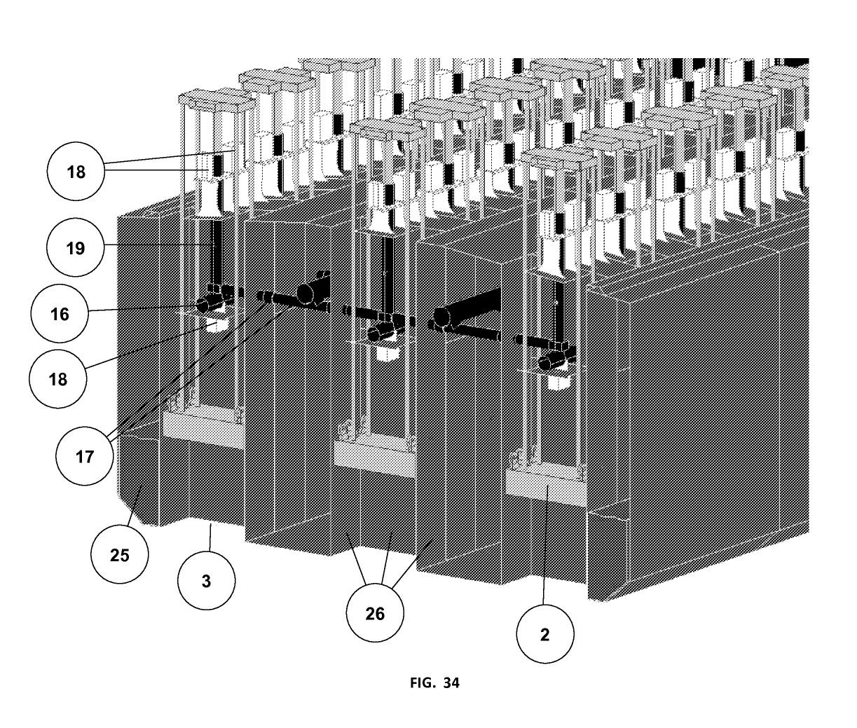

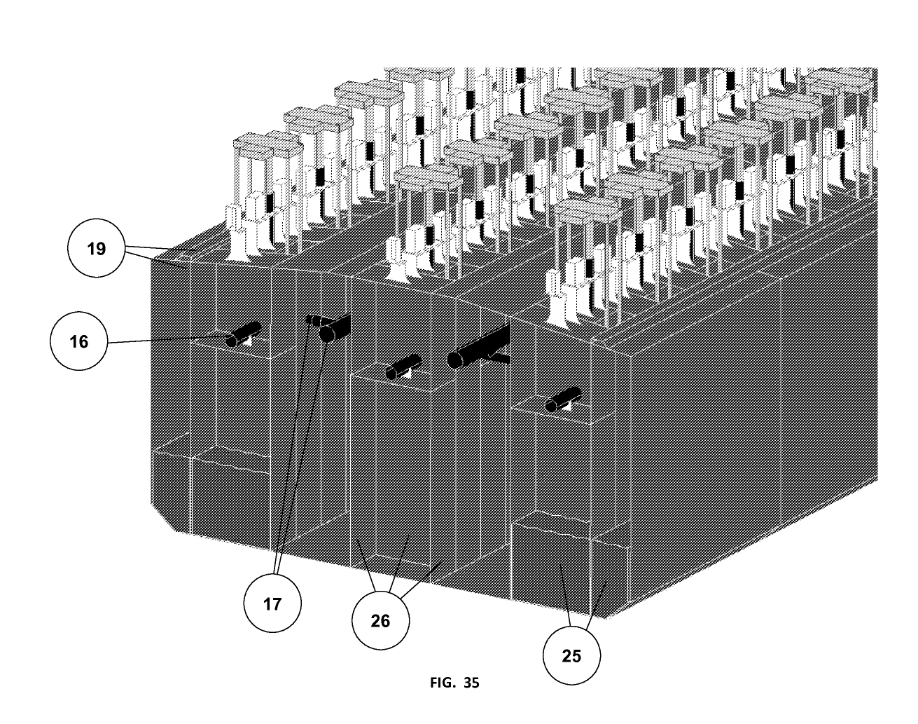

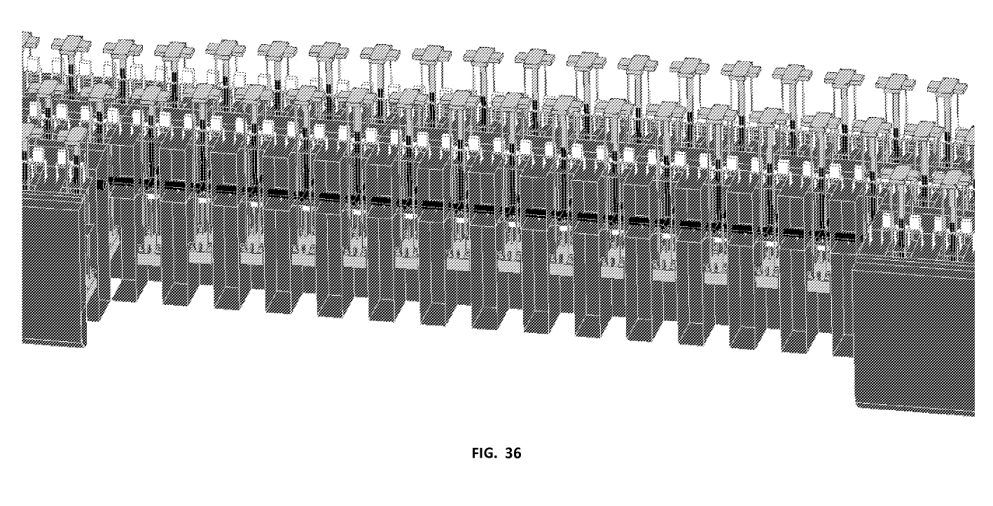

FIG. 28 through FIG. 36 depict alternate embodiments of the system. As illustrated in FIG. 34, high pressure fluid supply lines 16 are positioned below main deck. As further illustrated in FIG. 28, a single piston 13 per pump unit replaces the multiple pistons shown, for example, in FIG. 3. As shown in FIG. 34, the single piston shown in FIG. 28 or multiple pistons as shown in FIG. 3 may be positioned within the moon pools and eliminate the static pressure head by routing the low pressure return lines directly to the piston cylinders. The specific configuration of the system may be affected by various criteria, including access requirements, maintenance and repair plans, ease of assembly and safety, among others.

As shown in FIG. 8, embodiments of the apparatus include seventy-four moon pools 3 along the length of the vessel. It is anticipated that unobstructed openings at the ship bottom will allow for the maximum vertical oscillation of the water columns within moon pools 3. Alternatively, louvers, bottom plates or an altered moon pool shape may be used to reduce the entry of debris into the moon pools or to affect the oscillation of the water column and thus increase pump unit oscillation frequency or amplitude, thereby increasing power production. For example, the illustrative embodiments shown in the drawings include rectangular moon pools. However, the shape of the moon pools may be adjusted to another shape. In a further embodiment, the moon pools could include inlets that penetrate through the side shell or bow of the ship to increase vertical oscillations from a passing wave similar to a pilot tube where wave velocity can be converted into additional vertical oscillation.

FIG. 8 also identifies the typical water-tight structural bulkheads 26 within the apparatus. While the moon pool 3 and pump unit 2 sizes can be adjusted, the illustrated embodiments include 6 longitudinal bulkheads within the hull of the floating vessel 1. The vessel may to be constructed of steel and for a vessel of the appropriate size these bulkheads 26 may be necessary to supply the needed longitudinal strength of the vessel to resist hull girder bending stresses after introducing openings to the main deck and bottom plate.

In embodiments of the present invention, due consideration has been made to the loss of buoyancy incurred by constructing a floating vessel 1 with multiple moon pools 3. In the illustrated embodiments, the moon pools 3 remove approximately one third of the surface area on the bottom plate for buoyant forces to support the floating vessel. The illustrated vessel size is consistent with that of a very large crude carrier (VLCC) oil tanker. Because, the total ship weight or displacement will be considerably lighter than that of a fully loaded oil tanker, the floating vessel shall provide ample buoyancy. However, because the hydraulic system for energy generation and so many other components of the apparatus are above the floating vessel's 1 center of gravity, there may be a need for water ballast 25 (FIG. 5) in the bottom of the apparatus to provide stability. This is typical and an expected counter-balance system for any vessel of this size. For this same reason, any method of storing energy such as compressed air tanks or battery packs may be positioned in lower void spaces of the floating vessel 1 to lower the total center of gravity.

The illustrated embodiments of the invention depict an accommodation house 28 at the aft end of the apparatus similar to that found on cargo ships. It is anticipated that for stationary operation a very limited crew of personnel would be necessary for day to day operations if needed at all. Nevertheless, accommodations can be provided for vessel maintenance or repair.

As briefly described above, embodiments of the present invention may be applicable to a mobile apparatus. In such a mobile configuration, the generated electricity from the hydroelectric turbines may be used to rotate a shaft and propeller to propel a ship through the sea. Alternatively, for a mobile apparatus, the pressurized fluids 30 exiting the piston cylinders 19 could be routed to and expelled from the vessel to provide thrust. Replacement pumping fluid may be introduced into the system from the ambient fluid in which the vessel is floating, which would be seawater for a vessel floating on an ocean.

In alternative embodiments of the invention, the pumping process can be adjusted such that the piston cylinders 19 are dual-action cylinders, where both the rise and fall of the pump assembly 14 pumps fluid into the high pressure side 30 of the system. This alternative embodiment may be accomplished by adding additional inlet and exhaust valves above the pistons within the cylinders.

As briefly described, it may be advantageous to store the energy created by the vessel for later use. This may be useful to meet energy requirements during time periods of higher demand or to store energy for times when there is less wave action. This storage may be accomplished in a variety of ways. In one embodiment, the vessel may include one or more batteries or banks of batteries that could be charged by the generated electricity to store electrical energy. In an alternative embodiment, the pumped fluid and/or generated electricity could be used to compress and store a gas on the vessel. The later release of this gas could be used to generate electricity.

Embodiments of the invention described in this application relate to the use of wave action to create a high pressure fluid. The high pressure fluid is then used as an input to a hydraulic turbine, which converts the energy of the high pressure fluid into electrical energy. The generated electricity is then transmitted off the vessel for use on land or by another vessel. However, it is also contemplated that the high pressure, pumped fluid and /or the generated electricity could be used for other purposes. For example, the pumped fluid and/or generated electricity could be used to compress and transfer a gas off the vessel. This embodiment may be particularly useful in as part of or in connection with a liquefied natural gas (LNG) terminal.

In further embodiments, the pumped fluid could be used for a cooling process. The pumped fluid could be transferred to ballast tanks to increase ship stability. The pumped fluid and/or generated electricity could be used for the seawater injection process associated with extracting oil from wells. The pumped fluid could be transferred via pipeline to land or another offshore installation. The pumped fluid could be used for firefighting purposes.

In still further embodiments, the capacity of the vessel to generate electricity from wave action could be combined with or augmented by other electricity generating systems. For example, the vessel could include the installation of wind turbines and/or solar panels for additional power production. In addition, a platform could be constructed above the pump units for additional configurable space.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. As with any ship or floating platform, a variety of arrangements of machinery, structure and components is possible to ultimately perform the same intended operation.

I claim:

1. An apparatus for extracting energy from waves, comprising:
a) a support structure situated at a surface of a body of water;
b) a moon pool positioned within the support structure;
c) a float positioned within the moon pool, with the float adapted to rise and fall relative to the support structure with the rise and fall of a water column in the moon pool;
d) a linkage connecting the float with a piston such that the piston translates linearly in response to the movement of the float; and
e) a piston cylinder in which the piston translates, the piston cylinder comprising:
(i) an output, and
(ii) an input having a check valve that permits a fluid to enter the piston cylinder during the upward motion of the float relative to the support structure;
wherein, as the water column in a moon pool falls relative to the support structure, the float moves downward, and the fluid within the piston cylinder is pressurized.

2. The apparatus of claim 1, wherein the piston cylinder comprises a second check valve through which the pressurized fluid exits the piston cylinder.

3. The apparatus of claim 1, wherein the pressurized fluid exits the piston cylinder and the floater lowers until it is supported by the buoyant forces of the water.

4. The apparatus of claim 3 further comprising a high pressure supply line fluidly connected with the output of the piston cylinder.

5. The apparatus of claim 4 where the high pressure fluid is exhausted from the support structure to provide thrust and therefore move the support structure.

6. The apparatus of claim 4 further comprising a hydroelectric generator having an input fluidly connected with the high pressure supply line and an output.

7. The apparatus of claim 6 further comprising a holding tank fluidly connected with the output of the hydroelectric generator.

8. The apparatus of claim 7 further comprising a fluid return line fluidly connected with the holding tank.

9. The apparatus of claim 8 wherein the piston cylinder, the high pressure supply line, the hydroelectric generator, the holding tank and the fluid return line are fluidly connected to form a closed loop system.

10. The apparatus of claim 6 wherein the hydroelectric generator operates to generate electricity.

11. The apparatus of claim 6 wherein the hydroelectric generator is a turbine.

12. The apparatus of claim 9, wherein the generated electricity is transferred to land via a subsea electrical cable.

13. The apparatus of claim 10, wherein the generated electricity is transferred to an offshore installation via a subsea electrical cable.

14. The apparatus of claim 1 further comprising a mooring mechanism.

15. The apparatus of claim 14, wherein the mooring mechanism is a rotating turret.

16. The apparatus of claim 10, wherein at least a portion of the generated electricity is used to rotate a propeller that provides propulsion for the support structure.

17. The apparatus of claim 1 further comprising a second moon pool.

18. The apparatus of claim 1, wherein the support structure is a floating structure.

19. An apparatus for extracting energy from waves, comprising:
a) a support structure situated at the surface of a body of water;
b) a vertical column open to the water below and positioned within the support structure;
c) a float positioned within the vertical column, the float adapted to rise and fall relative to the support structure with the rise and fall of a water column in the vertical column;
d) a linkage connecting the float with a piston such that the piston translates linearly in response to the movement of the float;
e) a piston cylinder in which the piston translates, the translation of the piston in the piston cylinder operating to generate a pressurized fluid;
f) a hydroelectric generator having an input fluidly connected with the pressurized fluid.

20. An apparatus for extracting energy from waves, comprising:
a) a support structure situated at the surface of a body of water;
b) a vertical column open to the water below and positioned within the support structure;
c) a float positioned within the vertical column, the float adapted to rise and fall relative to the structure with the rise and fall of a water column in the vertical column;
d) a piston connected with the float such that the piston translates linearly in response the movement of the float;
e) a piston cylinder in which the piston translates, the translation of the piston in the piston cylinder operating to generate a pressurized fluid;
f) a hydroelectric generator having an input fluidly connected with the pressurized fluid; and
g) a flow control valve adapted to affect the flow of fluid to the hydroelectric generator.
